(19) United States
(12) Patent Application Publication
(10) Pub. No.: US 2022/0035558 A1
(43) Pub. Date: Feb. 3, 2022

(54) PHYSICAL STORAGE DRIVE WITH INFINITE STORAGE CAPACITY

(71) Applicant: Dell Products L.P., Round Rock, TX (US)

(72) Inventor: Rajiv Popat, Kolkata (IN)

(73) Assignee: Dell Products L.P., Round Rock, TX (US)

(21) Appl. No.: 16/944,567

(22) Filed: Jul. 31, 2020

(51) Int. Cl. G06F 3/06

(52) U.S. Cl. CPC G06F 3/0655; G06F 3/0604; G06F 3/067

(57) ABSTRACT

A peripheral storage system and method provide a separate host device with zero-configuration physical storage that has essentially unlimited capacity. The system simultaneously receives power from, and communicates data with, the host device using a standard port such as USB or SATA. A microcontroller in the peripheral storage system executes a virtual file system for storing data in a local data store, and a network interface controller (NIC) communicates data to a remote (e.g. cloud) data store whenever a Wi-Fi or cellular network connection is available. Data may be sent and received using checksums and/or encryption. The system and method may analyze data access patterns of the host device to perform adaptive caching. The peripheral storage system may be embodied as an integral part of the host device, or as a separate component having the form of, for example, a USB flash drive.

### FIELD

The disclosure pertains generally to electric digital data processing, and more particularly to networked storage systems adopting a particular infrastructure.

### BACKGROUND

Electronic computing devices, such as laptop, desktop, and tablet computers, MP3 music players, wearable fitness devices, smartphones, and the like, are familiar tools we encounter in everyday life. Such devices typically use a non-volatile storage device, such as a hard disk drive or a solid state (e.g. Flash) drive, to store an operating system, one or more useful applications or apps, and perhaps user data. However, non-volatile storage devices inherently have a finite storage capacity that limits the usefulness of the device. Moreover, this capacity often cannot be extended in mobile devices, given their compact nature.

Some solutions to the problem of finite storage include hardware such as disk arrays, and software such as distributed file systems. These solutions require the computing device to be specially configured with software, or to connect using an externally accessible data port (e.g. a USB port), or both. Disk arrays in particular are bulky and not particularly portable, making them cumbersome to use with laptop or tablet computers, especially with devices meant to be carried around like smartphones and wearable technology.

Remote, “cloud” storage technologies attempt to address this problem by substituting a network connection for a physical port. However, cloud storage still requires the coupled computing device to be specially configured with proprietary software. For example, to permit the computing device to backup and sync its data, Google Drive™ cloud storage by Google LLC of Mountain View, Calif. requires installation of a local application, or use of a proprietary and changing application programming interface (API) via a web browser or similar software. Individual files need to be separately uploaded and downloaded. By default, user data are stored unencrypted on a remote storage device, raising privacy concerns. When uploading or downloading all of the data, the local storage device needs at least as much data capacity as the cloud storage device. And, perhaps most importantly, the process of transferring data to and from cloud storage requires separate attention from the end user and is not seamlessly transparent.

### SUMMARY OF DISCLOSED EMBODIMENTS

Disclosed embodiments address the disadvantages of cloud storage by providing a local, physical storage system that appears to the host computing device to have unlimited capacity. The storage system operates as a seamless intermediary between the host device and a remote data store, such as a cloud storage service or system. The storage system receives data access (i.e. read and write) commands from the host device and executes them using a virtual file system driver. The driver determines whether the command can be completed locally, and does so when able, syncing any new data to the remote data store when a network connection is available. When the command requires accessing the remote data store, the intermediary storage system does so, returning the results. Data accesses may be analyzed, and remote data may be retrieved before they are accessed by the host device, thus improving performance.

A storage system and method as disclosed herein have many advantages. The storage system, which may take the shape of a thumb drive (USB Flash drive) or similar device, is highly portable, and may be powered by the host device. All proprietary configuration details of communicating with the remote data store may be programmed into the intermediary storage system, freeing the host device user from having to configure the system and making the system truly “plug-and-play.” Files may be distributed across multiple remote data stores, for example stores provided by different vendors, as a “community cloud.” In addition to providing additional physical storage, a data breach at any one vendor in this configuration will not result in the entire file being exposed. Alternately or in addition, data may be encrypted and decrypted by the storage system transparently, so that data stored remotely cannot be exposed even with a data breach. Because the encryption and decryption is purely for the benefit of a single device, it can be performed with a one-time pad stored or generated in the storage system itself. Thus, loss of the storage system will result in absolute unrecoverability of the data stored remotely, providing an extremely high level of security and trust.

Thus, a first embodiment is a system for communicatively coupling a host device to a remote data store. The system includes at least one port for receiving power from the host device and for sending data to and receiving data from the host device. The system also includes a microcontroller, coupled to the at least one port for sending data to and receiving data from the host device. The system further includes a local data store, coupled for sending data to and receiving data from the host device in response to receiving data storage commands from the microcontroller. And the system finally includes a network interface controller (NIC), coupled for sending data to and receiving data from the remote data store in response to receiving data storage commands from the microcontroller. The microcontroller, and the local data store, and the network interface controller are coupled to the at least one port to be powered by the host device using the received power.

In some embodiments, the host device comprises a laptop computer, or a tablet computer, or a music player, or a wearable fitness device, or a smartphone.

In some embodiments, the at least one port comprises a Universal Serial Bus (USB) port, or a Serial ATA (SATA) port, or both.

In some embodiments, the local data store comprises a volatile memory, or a non-volatile memory, or both.

In some embodiments, the NIC includes a subscriber identity module (SIM) for sending data to and receiving data from the remote data store using a cellular network.

In some embodiments, the microcontroller is configured to command the NIC for sending data to and receiving data from the remote data store according to a checksum, or an encryption protocol, or both.

In some embodiments, the microcontroller is configured to command the NIC for sending data to and receiving data from a plurality of remote data stores, of which the remote data store is one. The microcontroller may be further configured to perform a scatter-gather operation for a file in the local data store, using respective portions of the file in each of the plurality of remote data stores.

In some embodiments, the microcontroller is configured to analyze a data access pattern of the host device and, responsive to the analyzing, to command the NIC to retrieve a file from the remote data store before data access to the file is requested by the host device.

In some embodiments, the local data store stores data according to a file system format used by the host device.

Another embodiment is a method of executing a data access command regarding a given file, by a peripheral storage system attached to a host device. The method includes receiving, from the host device by a port in the peripheral storage system, the data access command. And the method includes executing, by a microprocessor in the peripheral storage system, a virtual file system driver. Executing the virtual file system driver includes, when the given file is not stored in a local data store in the peripheral storage system, instructing, by the microprocessor, a network interface controller (NIC) in the peripheral storage system to retrieve the given file from a remote data store into the local data store. Executing the virtual file system driver also includes executing the data access command with respect to the given file stored in the local data store. And executing the virtual file system driver includes communicating a result of the performance to the host device using the port. Executing the virtual file system driver comprises the microprocessor using electrical power received from the host device via the port.

In some embodiments, retrieving the given file from a remote data store comprises retrieving according to a checksum, or an encryption protocol, or both.

In some embodiments, retrieving the given file from a remote data store comprises retrieving from a plurality of remote data stores, of which the remote data store is one, according to a scatter-gather operation.

Some embodiments further include, by the microcontroller, analyzing a data access pattern of the host device and, responsive to the analyzing, commanding the NIC to retrieve a file from the remote data store before data access to the file is requested by the host device.

In some embodiments, executing the data access command comprises executing a command according to a file system format used by both the host device and the virtual file system driver.

Yet another embodiment is a tangible, computer-readable storage medium in a peripheral storage system attached to a host device, in which is non-transitorily stored computer program code for performing a method of executing, by the peripheral storage system, a data access command regarding a given file. The method programmed by the code includes receiving, from the host device by a port in the peripheral storage system, the data access command; and executing, by a microprocessor in the peripheral storage system, a virtual file system driver. Executing the virtual file system driver includes, when the given file is not stored in the storage medium, instructing, by the microprocessor, a network interface controller (NIC) in the peripheral storage system to retrieve the given file from a remote data store into the storage medium. Executing the virtual file system driver also includes executing the data access command with respect to the given file stored in the storage medium. And executing the virtual file system driver includes communicating a result of the performance to the host device using the port. Again, executing the virtual file system driver comprises the microprocessor using electrical power received from the host device via the port.

In some embodiments, retrieving the given file from a remote data store comprises retrieving according to a checksum, or an encryption protocol, or both.

In some embodiments, retrieving the given file from a remote data store comprises retrieving from a plurality of remote data stores, of which the remote data store is one, according to a scatter-gather operation.

In some embodiments, the method further includes, by the microcontroller, analyzing a data access pattern of the host device and, responsive to the analyzing, commanding the NIC to retrieve a file from the remote data store before data access to the file is requested by the host device.

In some embodiments, executing the data access command comprises executing a command according to a file system format used by both the host device and the virtual file system driver.

The above list of embodiments is not meant to be comprehensive or limiting, and a person having ordinary skill in the art may appreciate other ways to embody the concepts, techniques, and structures disclosed herein.

### DESCRIPTION OF THE SEVERAL VIEWS OF THE DRAWINGS

The manner and process of making and using the disclosed embodiments may be appreciated by reference to the drawings, in which:

FIG. 1 schematically shows a typical client-server system in which the disclosed concepts, techniques, and structures may be advantageously embodied;

FIG. 2 schematically shows relevant components of a system for communicatively coupling a host device to a remote data store according to a first embodiment;

FIG. 3 shows a flowchart of a method of executing a data access command regarding a given file, by a peripheral storage system attached to a host device in accordance with a second embodiment; and

FIG. 4 schematically shows relevant physical components of a computer 60 that may be used to embody the concepts, structures, and techniques disclosed herein.

### DETAILED DESCRIPTION OF EMBODIMENTS

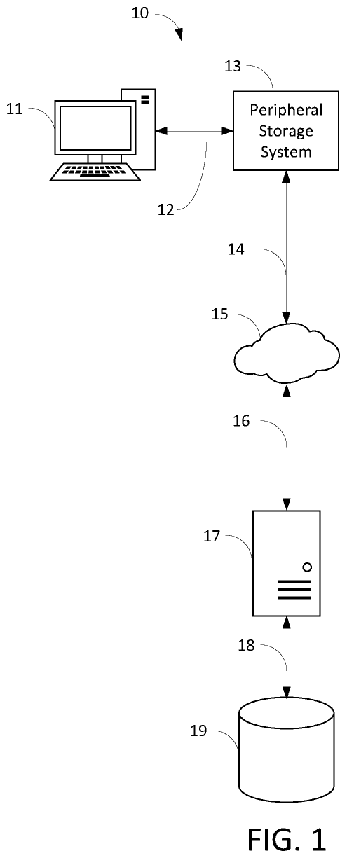

In FIG. 1 is schematically shown a typical client-server system 10 in which the disclosed concepts, techniques, and structures may be advantageously embodied. In accordance with client-server principles, the system 10 includes at least one client device coupled for bidirectional data communication with at least one server device using a data network. Generally, the client requests, via the data network, that the server perform a computation or other function, and the server responsively fulfills the request, optionally returning a result or status indicator to the client via the data network.

Thus, the system 10 includes a host device 11. The host device 11 is illustrated as a desktop computer, but may be any electronic device known in the art, including without limitation a laptop computer, tablet computer, smartphone, embedded system, or any other device capable of transmitting and receiving data, and requesting that another electronic device perform a computation.

The host device 11 is coupled, via a data link 12, to a peripheral storage system 13 in accordance with an embodiment of the concepts, techniques, and structures disclosed herein. The words “host” and “peripheral” are used in this sense as known in the art of data storage systems. That is, the “host device” is an electronic device as described above, which stores and retrieves data from the peripheral storage system. In various detachable embodiments, the peripheral storage system 13 is physically and removably coupled to the host device by insertion into a port on the host device, if the peripheral storage system 13 has a form factor appropriate for such insertion. In other, integrated embodiments, the peripheral storage system 13 is permanently or semi-permanently coupled to the host device as an internal peripheral card, or via an internal cable or other connector. In all such cases, a person having ordinary skill in the art should understand how to configure the data link 12 to accommodate the coupling.

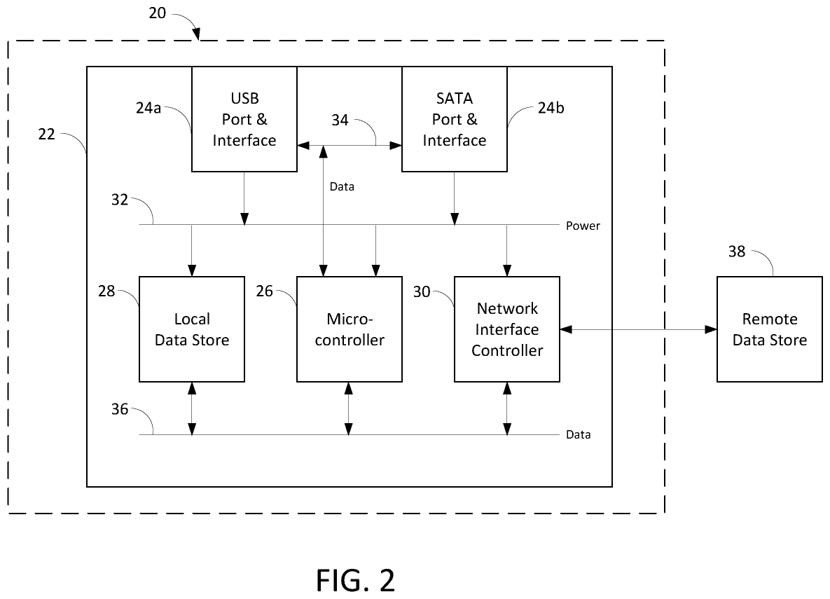

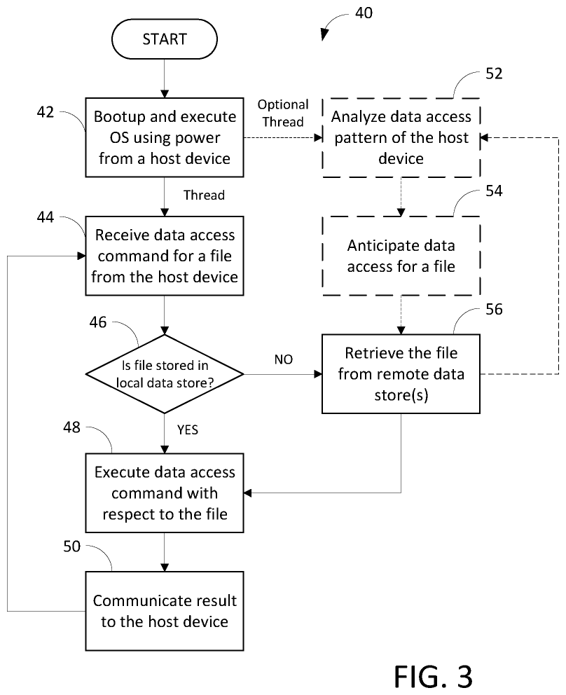

The peripheral storage system 13 is “peripheral” only in the sense of appearing, to the host device 11, as an otherwise black-box storage unit that operates according to an appropriate file system format—e.g. the File Allocation Table (FAT) format, or the NT File System (NTFS) format, or the Apple File System (APFS) format, or any other variety of file system format known in the art. The peripheral storage system 13 is described in greater detail below in connection with FIGS. 2 and 3, and acts as the “client” in the client-server paradigm described in connection with FIG. 1.

Thus, the peripheral storage system 13 is coupled, via a data link 14, to a data network 15. The data link 14 is any combination of hardware or software suited for communicating data between the peripheral storage system 13 and other electronic devices via the data network 15. The data link 14 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

The data network 15 is any combination of hardware or software suited for communicating data between electronic devices via data links. The data network 15 may be, for example, a local area network (“LAN”), a wide area network (“WAN”), a metropolitan area network (“MAN”), a virtual private network (“VPN”), the Internet, or any other type of data network.

It is appreciated that the data network 15 may operate to mediate data communication between multiple electronic devices. Thus, the depiction of only a single peripheral storage system 13 in FIG. 1 is merely illustrative, and a typical system 10 may have any number of such peripheral storage systems coupled for data communication, using corresponding data links to the data network 15. A typical system 10 also may have any number of host devices possessing peripheral storage systems, and each such host device (including the host device 11) may communicate using the data network 15 separately, for purposes unrelated to the present disclosure.

It is also appreciated that the data network 15 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

The data network 15 allows the peripheral storage system 13 to communicate with a server device 17, which is coupled to the data network 15 using a data link 16. The data link 16 is any combination of hardware or software suited for communicating data between the server device 17 and other electronic devices via the data network 15. The server device 17 may be any electronic device known in the art that is capable of transmitting and receiving data, and performing a computation on behalf of another electronic device.

Again, the data network 15 operates to mediate data communication between multiple electronic devices. Thus, the depiction of only a single server device 17 in FIG. 1 is merely illustrative, and a typical system 10 may have any number of server devices coupled for data communication, using corresponding data links to the data network 15. In particular, to provide simultaneous service to large numbers of client devices, a particular computation (or type of computation, such as rendering a web page) may be allocated to one of multiple server devices using a load balancer or other device. It is further appreciated that the server device 17, along with additional server devices if required, may provide well-defined operations known as “services” according to a service-oriented architecture (“SOA”), as those terms are known in the art.

It is appreciated in accordance with client-server principles that the designation of device 11 as the “client device” and device 17 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of the system 10, namely that the peripheral storage system 13 is the device requesting that a particular computation be performed on behalf of a user thereof, and that the server device 17 operates a “service” to perform the computation and communicate the results to the peripheral storage system 13. A typical protocol for such interaction is the Hypertext Transfer Protocol (“HTTP” or “HTTP/1.1”) specified as a proposed Internet Standard by Requests for Comment (“RFC”) 7260 through 7265, which is used to implement the World Wide Web.

FIG. 1 shows the server device 17 coupled, via a storage link 18, to a data storage device 19. The data storage device 19 may be a database, file system, volatile or non-volatile memory, network attached storage (“NAS”), storage area network (“SAN”), or any other hardware or software that is capable of storing data used by a server device 17 or a service executing thereon. The storage link 18 may be any hardware or software capable of communicating data between the server device 17 and the data storage device 19. It is appreciated that, where more than one server device 17 is present, multiple server devices may communicate with the same data storage device 19 to provide data sharing between the server devices.

It is appreciated that a requested computation may be done in several parts, thereby requiring the system 10 to retain an intermediate computational state between requests. If the services provided by the server device 17 do not store any such state (for example, to simplify their design), then the peripheral storage system 13 must supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

In FIG. 2 is schematically shown relevant functional components of a system 20 for communicatively coupling a host device to a remote data store 38. The system 20 may be used to implement the peripheral storage system 13 of FIG. 1, illustratively for coupling the host device 11 to the data storage device 19. In various embodiments, the host device may be a laptop computer, or a tablet computer, or a smartphone (e.g. one obtained from Dell Technologies Inc. of Round Rock, Tex.), or a music player (e.g. an iPod® mobile digital device from Apple Inc. of Cupertino, Calif.), or a wearable fitness device (e.g. a Fitbit® tracker or wristband from Fitbit, Inc. of San Francisco, Calif.), or an automobile computer (“carputer”).

The system 20 may include a chassis 22, one or more ports 24a, 24b (collectively, “ports 24”), a microcontroller 26, a local data store 28, a network interface controller (NIC) 30, a power bus 32, a host-side data bus 34, and an internal data bus 36. These components are described below in more detail. It is appreciated that the concepts, techniques, and structures described herein may be embodied in other foreseeable ways.

The chassis 22 may be any physical enclosure capable of housing the remainder of the components of the system 20. The chassis 22 may be made of any material known in the art for this purpose, and may provide a decorative exterior, or be semi-transparent, or completely transparent. In some embodiments, the chassis 22 has a shape, size, and weight that are amenable to portability, easy grasping with the hand, and physical coupling to the host device. In integrated embodiments, in which the system 20 is embedded inside the host device (e.g. as a peripheral on a printed circuit board (PCB)), the chassis 22 may be provided by the host device itself.

One or more ports 24 couple the system 20 to the host device. This coupling takes two forms: power coupling and data coupling. Thus, the ports 24 receive power from the host device, and the ports 24 permit sending data to and receiving data from the host device. This coupling may be facilitated by any coupling modality known in the art. Two illustrative modalities are the Universal Serial Bus (USB) and Serial ATA (SATA). Thus, the ports 24 in FIG. 2 comprise a USB port and interface 24a, and a SATA port and interface 24b. Such ports are well known in the art, as are the power and data interfaces to the system 20 which are typically implemented as integrated circuits.

It is appreciated that any number of ports 24 of any coupling modality may be used in an embodiment, and the depiction in FIG. 2 of two ports using the USB and SATA protocols, respectively, is merely illustrative. In integrated embodiments, the ports 24 are optional if other means exist for coupling the remaining components of the system 20, described below, to a power source and data bus of the host device. Such means may include, for example, a port using the Peripheral Component Interconnect (PCI), or any of its successors, or a similar interconnect.

The microcontroller 26 may be any microcontroller known in the art for providing computational functions in embedded systems, such as system 20. Thus, the microcontroller 26 may include one or more processing cores, volatile memory, and programmable inputs and outputs.

The local data store 28 may be any volatile or non-volatile data store, or a combination thereof, known in the art that conforms to the size and shape of the chassis 22. The local data store 28 is coupled to the microcontroller 26 for sending data to and receiving data from the host device in response to receiving data storage commands from the microcontroller 26. These commands may be, for example, to store data as a file or as a portion thereof, to read data as a file or as a portion thereof, to inquire as to the size of a file, or similar data storage commands known in the art. The local data store 28 may store data according to a file system format (e.g. FAT or NTFS) used by the host device, to facilitate rapid transfer of data between the host device and the system 20.

Illustratively, the local data store 28 may include a programmable read-only memory (PROM) in which is stored a light-weight operating system and one or more embedded applications or apps for carrying out the logical functions of the system 20 when executed by the microcontroller 26. In some embodiments, the PROM may be electrically erasable (i.e. it is an EEPROM), in which case its contents may be updated by the microcontroller 26 in response to appropriate commands received from the host device and data received from the host device or the remote data store 38. The local data store 28 also may include random access memory (RAM), such as Flash RAM, that the microcontroller 26 may use in performance of the embedded applications or for other purposes.

The network interface controller (NIC) 30 may be any NIC known in the art for sending data to, and receiving data from, another electronic device. In embodiments, the NIC 30 is used for communicating with the remote data store 38 in response to receiving data storage commands from the microcontroller 26. In embodiments for use with mobile devices, the NIC may communicate data wirelessly, illustratively using a Wi-Fi protocol or a cellular protocol using a wireless network. The wireless network may be, for example, a local area network (LAN), a wide area network (WAN), a satellite network, a cellular network, or any similar wireless network. The NIC 30 may incorporate a subscriber identity module (SIM) for communicating with one or more cellular networks when Wi-Fi is not available. The SIM may be compatible with any known cellular protocol, including the general packet radio service (GPRS), the global system for mobile communications (GSM), 3G/4G/5G data protocols, and other, similar technology known in the art. The NIC 30 is optional in integrated embodiments in which the host device already has a NIC, and in such cases the microcontroller 26 commands the NIC of the host device.

It is appreciated that the NIC 30 may be chosen to communicate with any appropriate remote data store 38. The remote data store 38 itself may store data, for use by the system 20, in a database, or a file system, or a volatile memory, or a non-volatile memory, or a network attached storage (NAS), or a storage area network (SAN), or any combination thereof. The remote data store 38 may store the data according to any data or file system format known in the art. It is further appreciated that, in situations where the NIC 30 is unable to access a data communication network or the remote data store 38, the system 20 advantageously may continue to operate as normal, external storage until such time as the data connection is restored.

The microcontroller 26 commands the NIC 30 according to data access commands received from the host device, and on its own initiative, when necessary to transmit data to, or receive data from, the remote data store 38. To provide increased reliability, the NIC 30 may transfer data to, or receive data from, the remote data store 38 according to a checksum. As is known in the art, checksums are metadata commonly stored and sent in parallel to requested data. Checksums are the result of applying a hash function to the data, mapping its value to a fixed, small number of bits (e.g. between 32 and 1024 bits). By applying the hash function to the received data and comparing the result to the received checksum, the data recipient can easily determine whether the data were correctly received. The use of a checksum can be transparently pre-configured by the peripheral storage system vendor, requiring no end-user setup.

Alternately or in addition, and to provide increased security, the NIC 30 may transfer data to, or receive data from, the remote data store 38 according to an encryption protocol. As is known in the art, encryption of data protects the data against viewing by undesired parties during storage in a data store, or during transit through a data communication network from the data store to the data consumer (i.e. the host device). Embodiments may encrypt data to be sent to the remote data store 38, and decrypt data received from the remote data store 38, according to any desired cryptographic protocol known in the art. This protocol may be implemented by the microcontroller 26, or by a separate integrated circuit such as a SIM for greater speed and to separate cryptographic processing from the computational work performed by the microcontroller 26. The use of data encryption can be transparently pre-configured by the peripheral storage system vendor, requiring no end-user setup.

Alternately or in addition, to provide even further security and added performance, the NIC 30 may transfer data to, and receive data from, multiple remote data stores, of which the remote data store 38 is only one. In accordance with a “scatter-gather” process, a single file may be broken into portions and “scattered” between (i.e. stored using) multiple remote data stores. In this way, if any single remote data store is compromised by a data breach, the entire file is not compromised. In accordance with this process, when a file is desired to be used by the host device, it is “gathered” and reassembled by the system 20 into the local data store using respective portions of the file in each of the remote data stores. Advantageously, if the host devices needs to use only a certain portion of the file, the system 20 must retrieve only that portion. Moreover, gathering data from multiple data stores can be faster than gathering data from a single data store because the total data transfer rate from multiple data stores is the sum of their individual transfer rates. The use of a scatter-gather process can be transparently pre-configured by the peripheral storage system vendor, requiring no end-user setup.

Embodiments further include a power bus 32 for powering the microcontroller 26, the local data store 28, and the NIC 30. The power bus 32 may be provided, for example, by wires or by circuit traces on a PCB. In operation, the system 20 receives power, from the host device to which it is coupled, in the ports 24 (or any of them), and that received power is provided internally by the power bus 32 to the microcontroller 26, the local data store 28, and the NIC 30. In particular, embodiments of the system 20 need not have any internal power supply or stored electrical charge (e.g. a battery). It is appreciated that embodiments may draw power from other sources, especially in integrated embodiments; however, in accordance with the concepts, techniques, and structures disclosed herein, the system 20 shown in FIG. 2 receives and applies at least some power from the ports 24 to the microcontroller 26, or the local data store 28, or the NIC 30, or a combination thereof.

In some embodiments, an operating voltage of the received power may differ from that of the components to which the power is supplied (i.e., the microcontroller 26, the local data store 28, and the NIC 30). In such cases, the system 20 may include one or more voltage dividers or multipliers (not shown) to provide power with the correct voltage to each respective component. Other properties of the received power may need to be modified for provision to the components; a person having ordinary skill in the art should understand how to appropriately condition the received power for this purpose.

As relevant to the present disclosure, the microcontroller 26 is coupled to the ports 24 via a host-side data bus 34 for sending data to and receiving data from the host device. Sending and receiving data may be performed by the host-side data bus 34 coupling the programmable inputs and outputs of the microcontroller to corresponding input and output pins in the ports 24. It is appreciated that the system 20 advantageously may be coupled to the host device using only one of the ports 24 at any given time, and that data need not be shared between the individual ports, but only between each such port and the microcontroller 26 via the host-side data bus 34. The host-side data bus 34 may be provided, for example, by wires or by circuit traces on a PCB.

In some embodiments, to reduce latency of data access, the microcontroller 26 may be configured to analyze a data access pattern of the host device to perform adaptive caching. That is, the analysis may indicate that, based on past data access commands, the host device is likely to soon request access to data that is not present in the local data store 28. Techniques for performing such an analysis are well known in the art, and “soon” is taken to mean slightly greater than the time that will be required to populate the missing data in the local data store 28. In response to determining that absent data are likely to be soon accessed, the microcontroller 26 may pre-emptively command the NIC 30 to retrieve the relevant file from the remote data store 38, before data access to the file is actually requested by the host device. In case the local data store 28 is full or nearly full, empty space to receive the pre-emptively retrieved file may be created by deleting a file or files from the local data store 28 according to any cache replacement algorithm known in the art, including a least recently used (LRU) algorithm or a least frequently used (LFU) algorithm. The use of adaptive caching can be transparently pre-configured by the peripheral storage system vendor, requiring no end-user setup.

The system 20 finally has an internal data bus 36 for communicating data between the microcontroller 26, the local data store 28, and the NIC 30. The internal data bus 36 may be provided, for example, by wires or by circuit traces on a PCB. The internal data bus 36 provides a data pathway inside the system 20 separate from host-side data bus 34, thus allowing different data communication protocols to be used for data sent to and received from the host device on the one hand, and data sent to and received from the local data store 28 and the NIC 30 on the other hand. However, it is appreciated that embodiments may use a single, combined data bus for all internal components (i.e. combining the host-side data bus 34 and the internal data bus 36), or other bus design known in the art, so the design of the data buses shown in FIG. 2 should not be viewed as limiting.

In FIG. 3 is shown a flowchart of a method 40 of executing a data access command regarding a given file, by a peripheral storage system attached to a host device in accordance with an embodiment. The data access commands may include, for example, read and write commands from the host device, or inquiries into the size of the given file or the file system in which it is stored. The peripheral storage system may be, illustratively, the peripheral storage system 13, or the system 20. The host device may be, illustratively, the host device 11. And the method 40 may use a remote data store, illustratively, the data storage device 19 or the remote data store 38.

The method 40 begins in the peripheral storage system with a bootup process 42. As is known in the art, a bootup process is used to bring an electronic device from a powered off state to a powered on and functioning state. The bootup process 42 thus may occur in embodiments each time the peripheral storage system is powered on.

In detachable embodiments, where the host device and the peripheral storage system are separately provided, the bootup process 42 may occur when the peripheral storage system is inserted into a port on the host device and thus begins to receive power. In these embodiments, the host device may have its own operating system (OS) and may be a smartphone, or a computer such as a tablet, desktop, or laptop. The host device OS will provide its own programming interface for storing data to a file system (i.e. file system drivers for various file systems, including FAT32 and NTFS) and for storing data to a peripheral storage system via a connecting port (i.e. peripheral drivers for various peripheral data communications protocols, like IDE, SATA, and USB).

In integrated embodiments, where the host device and the peripheral storage system are permanently or non-transiently coupled together, the bootup process 42 occurs when the host device is powered on. In these embodiments, the host device may be an MP3 player or wearable fitness device having an OS that provides file system drivers but may not provide peripheral drivers. Instead, the peripheral storage system is coupled to the host device via an internal connecting port.

In illustrative embodiments, regardless of the detachable or integrated relationship between the host device and the peripheral storage system, the latter is equipped with its own lightweight OS. In the bootup process 42, this peripheral storage system OS is brought to a functioning state using power from the host device via the connection port. In particular, a microprocessor in the peripheral storage system initializes a basic kernel. This kernel has drivers for the integrated hardware in the peripheral storage system, such as a flash drive and a Wi-Fi network interface controller (NIC). The peripheral storage system kernel also has a software driver for a virtual file system (VFS) that is able to execute data access commands. In some embodiments, the VFS provides data storage according to a file system format used by host device. Commands implementing the peripheral storage system OS may be stored in a read-only memory (ROM), especially an electrically erasable, programmable ROM (EEPROM) as described above. It is appreciated that in embodiments, the kernel may have more functionality than just described.

The lightweight OS of the peripheral storage system provides at least a single thread of execution that is responsive to receiving data access commands from the host device. That thread is indicated by the arrow from the bootup process 42 to the receiving process 44. In some embodiments, the lightweight OS provides another thread of execution for analyzing data access patterns of the host device, indicated by the arrow from the bootup process 42 to the analyzing process 52. Both of these threads are described below in more detail. It is appreciated that the lightweight OS may provide additional threads of execution for other purposes using known techniques in the art of multithreading, and that the concepts and techniques described in terms of threads may be implemented in other ways.

The basic execution flow of the first thread is as follows. The first thread begins with a receiving process 44, in which the peripheral storage system receives, from the host device by a port in peripheral storage system, a data access command for a file. The receiving process 44 may occur asynchronously, for example, when a user of the host device desires to read or write data to the file.

The microprocessor in the peripheral storage system provides the received data access command for the file to the VFS driver in its kernel. At this time, the method 40 proceeds to the decision process 46, in which the VFS driver determines whether the file is stored in a local data store, i.e. a data store in the peripheral storage system. If the answer is yes and the file is stored locally, then the method 40 proceeds to the executing process 48, in which the microprocessor executes, within the VFS driver, the data access command with respect to the given file stored in the local data store. Thus, if the data access command is a read operation, in process 48 the microprocessor executes the VFS driver to perform the read operation on the given file, and the same is true for any other data access command known in the art. The method 40 continues to responsive process 50, in which the microprocessor communicates the result of the performance of the data access command to the host device using the connecting port. The method 40 then returns in a loop to await the next data access command for the same file, or for a different file.

The thread as described above works well when each data access command pertains to a file already stored in the local data store, and thus this method is similar to the operation of USB Flash drives similar systems known in the art. Advantageously, however, embodiments disclosed herein supplement this operation by automatically and transparently fetching missing data from a remote data store. In “plug-and-play” embodiments, the user is not required to perform any configuration to obtain essentially unlimited storage, as the peripheral storage system may be pre-configured to automatically use storage provided by the peripheral storage system vendor or manufacturer. Importantly, this situation differs from prior art cloud drives requiring user configuration. Other embodiments may provide the user with the ability to configure the peripheral storage system to use remote data stores other than that provided by the vendor or manufacturer, or to configure the system as described in more detail below. However, in all cases, cloud-connected embodiments differ from prior art systems at least because they can be completely powered using the host device's own power.

Thus, the method 40 of FIG. 3 provides that, if the decision process 46 determines that a given file is not stored in the local data store of the peripheral storage system, the first thread proceeds to a retrieving process 56 in which the microprocessor instructs a network interface controller (NIC) in the peripheral storage system to retrieve the given file from one or more remote data stores into the local data store. The method 40 then proceeds to the above-described process 48, to execute the data access command with respect to the given file which is now stored in the local data store. The method 40 further provides that the above-described executing process 48 is modified, in the case of write data access commands, to further write data to the remote data store. Such writing may be performed using any appropriate synchronous (e.g. write-through) or asynchronous (e.g. write-back) algorithm known in the art.

Moreover, the NIC may in process 48 transfer data to, or in process 56 receive data from, the remote data store according to various modes described above. Thus, to provide increased reliability, the NIC may transfer data to, or receive data from, the remote data store according to a checksum. Alternately or in addition, and to provide increased security, the NIC may transfer data to, or receive data from, the remote data store according to an encryption protocol. Alternately or in addition, to provide even further security and added performance, the NIC may transfer data to, and receive data from, multiple remote data stores, of which the remote data store is only one, according to a “scatter-gather” operation.

Likewise, in some embodiments, to reduce latency of data access the microcontroller may be configured to analyze a data access pattern of the host device to perform adaptive caching. Such optional functionality may be implemented by the lightweight OS using a separate thread of execution. This thread of execution comprises processes 52, 54, and 56 of the method 40, as now described.

After the bootup process 42, the peripheral storage system may launch an optional analysis thread. This second thread begins with an analyzing process 52, in which the thread analyzes data access patterns of the host device to which it is attached. Techniques for performing such an analysis are well known in the art, and result in the process 54, in which the thread anticipates receipt, in the near future, of a data access command for a particular remote file determined by the analysis. “Near future” in this context means slightly longer than the time that will be required to populate the missing data in the local data store. If so, the second thread invokes the VFS driver using process 56 to retrieve the file from the one or more remote data stores. Note that this retrieval process 56 may use a checksum, or encryption, or a “scatter-gather” operation transparently, as described above. The use of these features can be transparently pre-configured by the peripheral storage system vendor, requiring no end-user setup. Following the retrieval process 56, the optional analysis thread may continue to analyze data access patterns of the host device, for example to determine other files to pre-emptively cache. Thus, the optional analysis thread follows the dashed arrow from process 56 to process 52.

In FIG. 3, the VFS driver comprises processes 46, 48, and 56. Thus, both the first and optional second threads may avail themselves of the functionality provided by the VFS driver, especially retrieving process 56 in its various modes. It is appreciated that the VFS driver in a lightweight OS may include other processes, which are not shown in FIG. 3. It is further appreciated that these processes may be executed by “user space” processes outside of a kernel, rather than as a “driver” executing within a kernel, as those terms are used in the art, and thus that the above description of these processes as occurring within a VFS driver should not be viewed as limiting.

It is appreciated that the VFS driver may provide other functions that relate to a given file but are not described above. For example, the VFS driver may respond to a data access command requesting the size of the given file. If the file is stored in the local data store, the VFS driver can use known file system techniques to determine the size of the file directly. However, if the file is not stored in the local data store, the VFS driver can query the one or more remote data stores to determine the size of the full file. A person having ordinary skill in the art of file systems should understand how to implement these other file-specific functions.

It is further appreciated that the VFS driver may provide functions that do not relate to particular files, but to the file system as a whole. For example, the VFS driver may respond to a data access command requesting the size of a file system. In this case, the VFS driver may respond with a contrived size (e.g. the largest possible size MAX INTEGER) to indicate that the storage provided by the peripheral storage system is functionally limitless. A person having ordinary skill in the art of file systems should understand how to implement these other filesystem-specific functions.

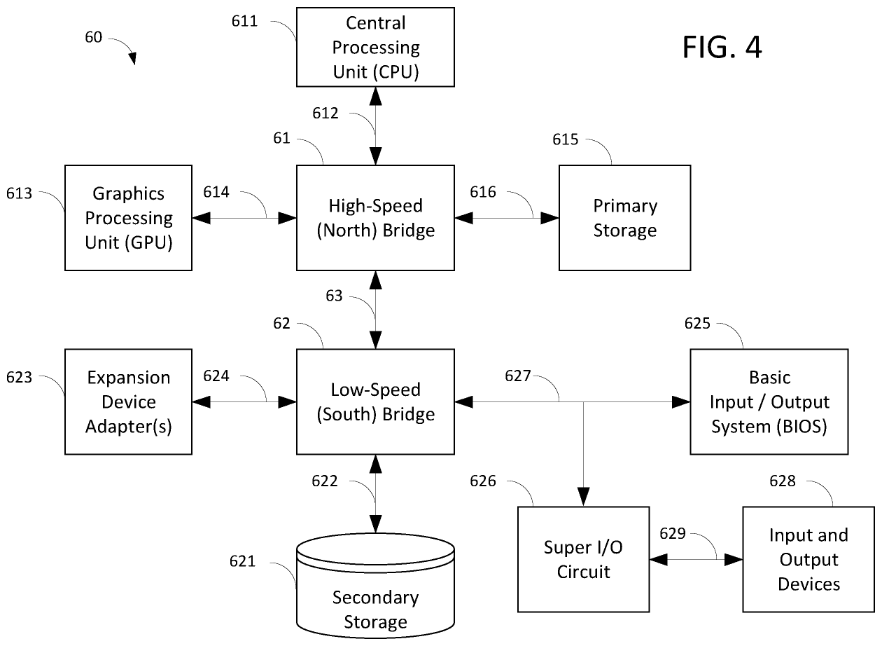

In FIG. 4 is schematically shown relevant physical components of a computer 60 that may be used to embody the concepts, structures, and techniques disclosed herein. In particular, the computer 60 may be used, in whole or in part, to implement the host device 11, or the peripheral storage system 13, or the data network 15, or the server device 17, or the data storage device 19, or the system 20, or the remote data store 38, or the method 40 or any of its processes. Generally, the computer 60 has many functional components that communicate data with each other using data buses. The functional components of FIG. 4 are physically arranged based on the speed at which each must operate, and the technology used to communicate data using buses at the necessary speeds to permit such operation.

Thus, the computer 60 is arranged as high-speed components and buses 611 to 616 and low-speed components and buses 621 to 629. The high-speed components and buses 611 to 616 are coupled for data communication using a high-speed bridge 61, also called a “northbridge,” while the low-speed components and buses 621 to 629 are coupled using a low-speed bridge 62, also called a “southbridge.”

The computer 60 includes a central processing unit (“CPU”) 611 coupled to the high-speed bridge 61 via a bus 612. The CPU 611 is electronic circuitry that carries out the instructions of a computer program. As is known in the art, the CPU 611 may be implemented as a microprocessor; that is, as an integrated circuit (“IC”; also called a “chip” or “microchip”). In some embodiments, the CPU 611 may be implemented as a microcontroller for embedded applications, or according to other embodiments known in the art.

The bus 612 may be implemented using any technology known in the art for interconnection of CPUs (or more particularly, of microprocessors). For example, the bus 612 may be implemented using the HyperTransport architecture developed initially by AMD, the Intel QuickPath Interconnect (“QPI”), or a similar technology. In some embodiments, the functions of the high-speed bridge 61 may be implemented in whole or in part by the CPU 611, obviating the need for the bus 612.

The computer 60 includes one or more graphics processing units (GPUs) 613 coupled to the high-speed bridge 61 via a graphics bus 614. Each GPU 613 is designed to process commands from the CPU 611 into image data for display on a display screen (not shown). In some embodiments, the CPU 611 performs graphics processing directly, obviating the need for a separate GPU 613 and graphics bus 614. In other embodiments, a GPU 613 is physically embodied as an integrated circuit separate from the CPU 611 and may be physically detachable from the computer 60 if embodied on an expansion card, such as a video card. The GPU 613 may store image data (or other data, if the GPU 613 is used as an auxiliary computing processor) in a graphics buffer.

The graphics bus 614 may be implemented using any technology known in the art for data communication between a CPU and a GPU. For example, the graphics bus 614 may be implemented using the Peripheral Component Interconnect Express (“PCI Express” or “PCIe”) standard, or a similar technology.

The computer 60 includes a primary storage 615 coupled to the high-speed bridge 61 via a memory bus 616. The primary storage 615, which may be called “main memory” or simply “memory” herein, includes computer program instructions, data, or both, for use by the CPU 611. The primary storage 615 may include random-access memory (“RAM”). RAM is “volatile” if its data are lost when power is removed, and “non-volatile” if its data are retained without applied power. Typically, volatile RAM is used when the computer 60 is “awake” and executing a program, and when the computer 60 is temporarily “asleep”, while non-volatile RAM (“NVRAM”) is used when the computer 60 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 616 may be implemented using any technology known in the art for data communication between a CPU and a primary storage. The memory bus 616 may comprise an address bus for electrically indicating a storage address, and a data bus for transmitting program instructions and data to, and receiving them from, the primary storage 615. For example, if data are stored and retrieved 64 bits (eight bytes) at a time, then the data bus has a width of 64 bits. Continuing this example, if the address bus has a width of 32 bits, then 2³² memory addresses are accessible, so the computer 60 may use up to 8*2³²=32 gigabytes (GB) of primary storage 615. In this example, the memory bus 616 will have a total width of 64+32=96 bits. The computer 60 also may include a memory controller circuit (not shown) that converts electrical signals received from the memory bus 616 to electrical signals expected by physical pins in the primary storage 615, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 611, the graphics processing units 613, the primary storage 615, and the high-speed bridge 61, or any combination thereof, as a single integrated circuit. In such embodiments, buses 612, 614, 616 may form part of the same integrated circuit and need not be physically separate. Other designs for the computer 60 may embody the functions of the CPU 611, graphics processing units 613, and the primary storage 615 in different configurations, obviating the need for one or more of the buses 612, 614, 616.

The depiction of the high-speed bridge 61 coupled to the CPU 611, GPU 613, and primary storage 615 is merely exemplary, as other components may be coupled for communication with the high-speed bridge 61. For example, a network interface controller (“NIC” or “network adapter”) may be coupled to the high-speed bridge 61, for transmitting and receiving data using a data channel. The NIC may store data to be transmitted to, and received from, the data channel in a network data buffer.

The high-speed bridge 61 is coupled for data communication with the low-speed bridge 62 using an internal data bus 63. Control circuitry (not shown) may be required for transmitting and receiving data at different speeds. The internal data bus 63 may be implemented using the Intel Direct Media Interface (“DMI”) or a similar technology.

The computer 60 includes a secondary storage 621 coupled to the low-speed bridge 62 via a storage bus 622. The secondary storage 621, which may be called “auxiliary memory”, “auxiliary storage”, or “external memory” herein, stores program instructions and data for access at relatively low speeds and over relatively long durations. Since such durations may include removal of power from the computer 60, the secondary storage 621 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 622 may be implemented using any technology known in the art for data communication between a CPU and a secondary storage and may include a host adaptor (not shown) for adapting electrical signals from the low-speed bridge 62 to a format expected by physical pins on the secondary storage 621, and vice versa. For example, the storage bus 622 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 60 also includes one or more expansion device adapters 623 coupled to the low-speed bridge 62 via a respective one or more expansion buses 624. Each expansion device adapter 623 permits the computer 60 to communicate with expansion devices (not shown) that provide additional functionality. Such additional functionality may be provided on a separate, removable expansion card, for example an additional graphics card, network card, host adaptor, or specialized processing card.

Each expansion bus 624 may be implemented using any technology known in the art for data communication between a CPU and an expansion device adapter. For example, the expansion bus 624 may transmit and receive electrical signals using a Peripheral Component Interconnect (“PCI”) standard, a data networking standard such as an Ethernet standard, or a similar technology.

The computer 60 includes a basic input/output system (“BIOS”) 625 and a Super I/O circuit 626 coupled to the low-speed bridge 62 via a bus 627. The BIOS 625 is a non-volatile memory used to initialize the hardware of the computer 60 during the power-on process. The Super I/O circuit 626 is an integrated circuit that combines input and output (“I/O”) interfaces for low-speed input and output devices 628, such as a serial mouse and a keyboard. In some embodiments, BIOS functionality is incorporated in the Super I/O circuit 626 directly, obviating the need for a separate BIOS 625.

The bus 627 may be implemented using any technology known in the art for data communication between a CPU, a BIOS (if present), and a Super I/O circuit. For example, the bus 627 may be implemented using a Low Pin Count (“LPC”) bus, an Industry Standard Architecture (“ISA”) bus, or similar technology. The Super I/O circuit 626 is coupled to the I/O devices 628 via one or more buses 629. The buses 629 may be serial buses, parallel buses, other buses known in the art, or a combination of these, depending on the type of I/O devices 628 coupled to the computer 60.

The techniques and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, techniques, and structures which are the subject of this disclosure, it will now become apparent to those of ordinary skill in the art that other implementations incorporating these concepts, techniques, and structures may be used. Accordingly, it is submitted that that scope of the patent should not be limited to the described implementations but rather should be limited only by the spirit and scope of the following claims.

What is claimed is:

1. A system for communicatively coupling a host device to a remote data store, the system comprising:
at least one port for receiving power from the host device and for sending data to and receiving data from the host device;
a microcontroller, coupled to the at least one port for sending data to and receiving data from the host device;
a local data store, coupled for sending data to and receiving data from the host device in response to receiving data storage commands from the microcontroller; and
a network interface controller (NIC), coupled for sending data to and receiving data from the remote data store in response to receiving data storage commands from the microcontroller;
wherein the microcontroller, and the local data store, and the network interface controller are coupled to the at least one port to be powered by the host device using the received power.

2. The system according to claim 1, wherein the host device comprises a laptop computer, or a tablet computer, or a music player, or a wearable fitness device, or a smartphone, or a carputer.

3. The system according to claim 1, wherein the at least one port comprises a Universal Serial Bus (USB) port, or a Serial ATA (SATA) port, or both.

4. The system according to claim 1, wherein the local data store comprises a volatile memory, or a non-volatile memory, or both.

5. The system according to claim 1, wherein the NIC includes a subscriber identity module (SIM) for sending data to and receiving data from the remote data store using a cellular network.

6. The system according to claim 1, wherein the microcontroller is configured to command the NIC for sending data to and receiving data from the remote data store according to a checksum, or an encryption protocol, or both.

7. The system according to claim 1, wherein the microcontroller is configured to command the NIC for sending data to and receiving data from a plurality of remote data stores, of which the remote data store is one.

8. The system according to claim 7, wherein the microcontroller is further configured to perform a scatter-gather operation for a file in the local data store, using respective portions of the file in each of the plurality of remote data stores.

9. The system according to claim 1, wherein the microcontroller is configured to analyze a data access pattern of the host device and, responsive to the analyzing, to command the NIC to retrieve a file from the remote data store before data access to the file is requested by the host device.

10. The system according to claim 1, wherein the local data store stores data according to a file system format used by the host device.

11. A method of executing a data access command regarding a given file, by a peripheral storage system attached to a host device, the method comprising:
receiving, from the host device by a port in the peripheral storage system, the data access command; and
executing, by a microprocessor in the peripheral storage system, a virtual file system driver, wherein executing includes:
when the given file is not stored in a local data store in the peripheral storage system, instructing, by the microprocessor, a network interface controller (NIC) in the peripheral storage system to retrieve the given file from a remote data store into the local data store;
executing the data access command with respect to the given file stored in the local data store; and
communicating a result of the performance to the host device using the port;
wherein executing the virtual file system driver comprises the microprocessor using electrical power received from the host device via the port.

12. The method according to claim 11, wherein retrieving the given file from a remote data store comprises retrieving according to a checksum, or an encryption protocol, or both.

13. The method according to claim 11, wherein retrieving the given file from a remote data store comprises retrieving from a plurality of remote data stores, of which the remote data store is one, according to a scatter-gather operation.

14. The method according to claim 11, further comprising, by the microcontroller, analyzing a data access pattern of the host device and, responsive to the analyzing, commanding the NIC to retrieve a file from the remote data store before data access to the file is requested by the host device.

15. The method according to claim 11, wherein executing the data access command comprises executing a command according to a file system format used by both the host device and the virtual file system driver.

16. A tangible, computer-readable storage medium in a peripheral storage system attached to a host device, in which is non-transitorily stored computer program code for performing a method of executing, by the peripheral storage system, a data access command regarding a given file, the method comprising:
receiving, from the host device by a port in the peripheral storage system, the data access command; and
executing, by a microprocessor in the peripheral storage system, a virtual file system driver, wherein executing includes:
when the given file is not stored in the storage medium, instructing, by the microprocessor, a network interface controller (NIC) in the peripheral storage system to retrieve the given file from a remote data store into the storage medium;
executing the data access command with respect to the given file stored in the storage medium; and
communicating a result of the performance to the host device using the port;
wherein executing the virtual file system driver comprises the microprocessor using electrical power received from the host device via the port.

17. The storage medium according to claim 16, wherein retrieving the given file from a remote data store comprises retrieving according to a checksum, or an encryption protocol, or both.

18. The storage medium according to claim 16, wherein retrieving the given file from a remote data store comprises retrieving from a plurality of remote data stores, of which the remote data store is one, according to a scatter-gather operation.

19. The storage medium according to claim 16, wherein the method further includes, by the microcontroller, analyzing a data access pattern of the host device and, responsive to the analyzing, commanding the NIC to retrieve a file from the remote data store before data access to the file is requested by the host device.

20. The storage medium according to claim 16, wherein executing the data access command comprises executing a command according to a file system format used by both the host device and the virtual file system driver.
